(19) United States
(12) Patent Application Publication
(10) Pub. No.: US 2009/0003277 A1
(43) Pub. Date: Jan. 1, 2009

(54) System, Method and Computer Program Product for Providing Increased Bandwidth in a Broadband Wireless Communication System

(75) Inventor: Anand Uppili, Bangalore (IN)

Correspondence Address: FIALA & WEAVER, P.L.L.C.;C/O INTELLEVATE, P.O. BOX 52050, MINNEAPOLIS, MN, 55402, US

(73) Assignee: TORRES NETWORKS, LTD., Dublin (IE)

(21) Appl. No.: 11/769,792

(22) Filed: Jun. 28, 2007

(51) Int. Cl. H04Q 7/00

(52) U.S. Cl. 370/331

(57) ABSTRACT

A system, method and computer program product is described that facilitates the provision of increased bandwidth in a broadband wireless communication system, such as a WiMAX communication system, by initiating and performing a hot handover of an active mobile communication session from a first base station to a second base station. The first base station may be a low-capacity base station and the second base station may be a high-capacity base station. The hot handover occurs even in instances where the mobile station is receiving a stronger signal from the first base station than the second base station. The hot handover is initiated by an entity separate from the mobile station. This entity makes the handover decision based upon inputs from the broadband wireless communication network and optionally from overlay Operations Support System (OSS) and/or Business Support System (BSS) components.

### BACKGROUND OF THE INVENTION

1. Field of the Invention

The invention generally relates to broadband wireless communication systems. More specifically, the invention is related to a system, method and computer program product that facilitates the provision of increased bandwidth in a broadband wireless communication system.

2. Background

WiMAX (“Worldwide Interoperability for Microwave Access”) is a term used to describe standard interoperable implementations of IEEE 802.16 broadband wireless communication systems. A WiMAX communication system can provide broadband wireless access for up to 30 miles for fixed subscriber stations, and 3-10 miles for mobile subscriber stations. In contrast, Wi-Fi wireless local area networks, which implement IEEE 802.11, are limited in most cases to only 100-300 feet. The bandwidth and reach of WiMAX make it suitable for many applications, including connecting Wi-Fi hotspots with each other and other parts of the Internet, providing a wireless alternative to cable and DSL for “last mile” broadband access, and providing high-speed mobile data and telecommunications services. With respect to the latter application, enormous investments are currently being made to develop and deploy a fourth generation (4G) nationwide broadband mobile network based on the mobile WiMAX standard, IEEE 802.16e-2005.

One concern in using WiMAX for mobile data and telecommunications services is the bandwidth limitations inherent in the technology's cellular architecture. WiMAX operators typically obtain 10 megahertz (MHz) of radio frequency (RF) bandwidth. When allocated across a cellular network using conventional technology, this 10 MHz of RF bandwidth roughly translates to about 8 megabits per second (Mbps) of throughput or effective bandwidth per base station. A WiMAX base station must use this bandwidth to support numerous simultaneous voice and data users. The bandwidth presently available does not make a compelling business case for widespread deployment as the cost of the base station is divided between only a handful of users. Also, if too many users attach themselves to a given cell, the resulting bandwidth consumption may cause a reduction or loss of service for one or more users. To contend with these issues, a WiMAX operator must obtain more RF bandwidth from the regulator, which is expensive and in many cases simply not available. Consequently, there is a great need for a technology that will provide increased effective bandwidth per WiMAX cell without having to obtain more RF bandwidth.

### BRIEF SUMMARY OF THE INVENTION

The present invention facilitates the provision of increased bandwidth in a broadband wireless communication system, such as a WiMAX communication system.

In particular, one embodiment of the present invention is a method for performing a handover in a broadband wireless communication system, such as a WiMAX communication system. The method includes acquiring information from a mobile station that is engaged in an active mobile communication session over the broadband wireless communication system via a wireless link to a first base station, wherein the acquired information indicates that the mobile station is capable of wirelessly communicating with both the first base station and a second base station and also indicates that the strength of a signal from the second base station does not exceed the strength of a signal from the first base station. Based at least in part on the information acquired from the mobile station, commands are sent to the first base station and the second base station to transfer the active mobile communication session from the first base station to the second base station.

The active mobile communication session may be one of a voice, data or video communication session.

In one embodiment, the sending of commands to the first base station and the second base station to transfer the active mobile communication session from the first base station to the second base station comprises performing a network initiated handover in accordance with an IEEE 802.16 standard.

In a further embodiment, the second base station has a higher capacity than the first base station.

In a still further embodiment, the step of sending commands to the first base station and the second base station to transfer the active mobile communication session from the first base station to the second base station is performed based also on information acquired from a component in a telecommunications network indicating that a subscriber associated with the mobile station is eligible for a handover from the first base station to the second base station or based on a command received from a component in the telecommunications network indicating that the mobile station should be transferred from the first base station to the second base station. The component in the telecommunications network may be an Operations Support System (OSS) component or a Business Support System (BSS) component.

Another embodiment of the present invention is a server for use in a telecommunications network that includes a broadband wireless communication system, such as a WiMAX communication system. The server includes a first interface and a logic engine communicatively connected to the first interface. The logic engine is configured to acquire via the first interface information from a mobile station that is engaged in an active mobile communication session over the broadband wireless communication system via a wireless link to a first base station, wherein the acquired information indicates that the mobile station is capable of wirelessly communicating with both the first base station and a second base station and also indicates that the strength of a signal from the second base station does not exceed the strength of a signal from the first base station. The logic engine is further configured to send via the first interface commands to the first base station and the second base station to transfer the active mobile communication session from the first base station to the second base station based at least in part on the information acquired from the mobile station.

The active mobile communication session may be one of a voice, data or video communication session.

In one embodiment, the logic engine is configured to send commands to the first base station and the second base station to transfer the active mobile communication session from the first base station to the second base station as part of a network initiated handover in accordance with an IEEE 802.16 standard.

In a further embodiment, the second base station has a higher capacity than the first base station.

In a still further embodiment, the server further comprises a second interface to which the logic engine is communicatively connected. The logic engine is further configured to acquire information via the second interface from a component in the telecommunications network indicating that a subscriber associated with the mobile station is eligible for a handover from the first base station to the second base station, and to send commands to the first base station and the second base station to transfer the active mobile communication session from the first base station to the second base station based at least in part on the information acquired from the mobile station and the information acquired from the component in the telecommunications network. The component in the telecommunications network may comprise an OSS component or a BSS component.

Alternatively, the logic engine is further configured to receive a command via the second interface from a component in the telecommunications network indicating that the mobile station should be transferred from the first base station to the second base station, and to send commands to the first base station and the second base station to transfer the active mobile communication session from the first base station to the second base station based at least in part on the information acquired from the mobile station and the command received from the component in the telecommunications network. The component in the telecommunications network may comprise an OSS component or a BSS component.

Yet another embodiment of the present invention is a computer program product comprising a computer useable medium having computer program logic recorded thereon for enabling a processor to initiate a handover in a broadband wireless communication network, such as a WiMAX communication network. The computer program logic includes first means for enabling the processor to acquire information from a mobile station that is engaged in an active mobile communication session over the broadband wireless communication system via a wireless link to a first base station, wherein the acquired information indicates that the mobile station is capable of wirelessly communicating with both the first base station and a second base station and also indicates that the strength of a signal from the second base station does not exceed the strength of a signal from the first base station. The computer program logic also includes second means for enabling the processor to send commands to the first base station and the second base station to transfer the active mobile communication session from the first base station to the second base station based at least in part on the information acquired from the mobile station.

The active mobile communication session may be one of a voice, data or video communication session.

In one embodiment, the second means comprises means for enabling the processor to initiate a network initiated handover in accordance with an IEEE 802.16 standard.

In a further embodiment, the second base station has a higher capacity than the first base station.

In a still further embodiment of the present invention, the computer program logic includes third means for enabling the processor to acquire information from a component in a telecommunications network indicating that a subscriber associated with the mobile station is eligible for a handover from the first base station to the second base station. In accordance with such an embodiment, the second means comprise means for enabling the processor to send commands to the first base station and the second base station to transfer the active mobile communication session from the first base station to the second base station based at least in part on the information acquired from the mobile station and the information acquired from the component in the telecommunications network. The component in the telecommunications network may comprise an OSS component or a BSS component.

Alternatively, the third means may be for enabling the processor to receive a command from a component in a telecommunications network indicating that the mobile station should be transferred from the first base station to the second base station. In accordance with such an embodiment, the second means comprises means for enabling the processor to send commands to the first base station and the second base station to transfer the active mobile communication session from the first base station to the second base station based at least in part on the information acquired from the mobile station and the command received from the component in the telecommunications network. The component in the telecommunications network may comprise an OSS component or a BSS component.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 depicts a portion of a conventional cellular telephone system that supports a “cold handover” of a cellular telephone call from a first base station to a second base station.

FIG. 2 depicts a portion of a broadband wireless communication system that supports a “hot handover” of an active mobile communication session from a first base station to a second base station in accordance with an embodiment of the present invention.

FIG. 3 is a high-level block diagram of a telecommunications network in which an embodiment of the present invention may operate.

FIG. 4 is a high-level block diagram of a server that is configured to perform functions associated with performing a hot handover in accordance with an embodiment of the present invention.

FIG. 5 illustrates a flowchart of various steps associated with performing a hot handover in accordance with an embodiment of the present invention.

FIG. 6 illustrates a message flow associated with an initial setup step of a hot handover process in accordance with an embodiment of the present invention.

FIG. 7 illustrates a message flow associated with a comparison step and a decision step of a hot handover process in accordance with an embodiment of the present invention.

FIGS. 8 and 9 illustrate message flows associated with a call transfer step of a hot handover process in accordance with an embodiment of the present invention.

FIG. 10 illustrates a message flow associated with a closure step of a hot handover process in accordance with an embodiment of the present invention.

FIG. 11 depicts an example processor-based computer system in which features of the present invention may be implemented.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Overview

An embodiment of the present invention facilitates the provision of increased bandwidth in a broadband wireless communication system, such as a WiMAX communication system, that is used for high-speed mobile data and telecommunications services. As will be described in more detail herein, this goal is achieved through the deployment of novel functionality within a telecommunications network that enables the network to transfer an active mobile communication session with a mobile station from a first base station (also referred to herein as the “originating base station”) to a second base station (also referred to herein as the “terminating base station”). An embodiment of the present invention advantageously permits this transfer to be achieved without dropping the communication session and without the user of the mobile station being aware of the transfer.

The active mobile communication session may be any type of voice, data or video communication session that can be carried out via a broadband wireless communication system. One example of a voice communication session is a Voice over Internet Protocol (VoIP) telephone call between a mobile station, such as a portable phone, personal digital assistant (PDA) or laptop, and another entity. A data communication session may comprise communications associated with the use of a mobile station, such as a PDA or laptop, for Internet access, Intranet access, or any other value-added data application. A video communication session may comprise communications associated with the streaming of video to a mobile station, such as an Apple iPOD® or other portable media player, for viewing by an end user. However, these examples are not intended to be limiting, and the present invention may be used with other types of voice, data or video communication sessions.

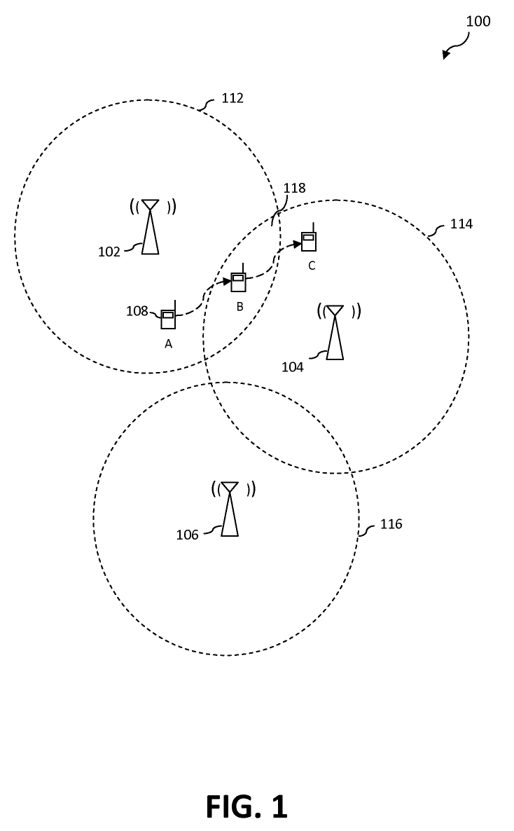

Generally speaking, the concept of transferring an active mobile communication session between base stations is not new. The process, which has alternately been referred to as “switching”, “handover” or “handoff,” has traditionally been used in cellular telephone systems to maintain a telephone call while a subscriber is moving through several cell site areas. This conventional handover process will now be described with reference to FIG. 1.

FIG. 1 depicts a portion of a cellular telephone system 100 that includes a first base station 102, a second base station 104, and a third base station 106, each of which has a respective coverage area 112, 114 and 116. The coverage area of each base station is that area over which it is capable of wirelessly communicating with cellular telephones and is typically configured to be coextensive with a designated cell site area. As further shown in FIG. 1, a cellular telephone 108 is being carried from coverage area 112 of first base station 102 to coverage area 114 of second base station 104.

In the conventional scenario, as cellular telephone 108 moves from coverage area 112 to coverage area 114, a handover from base station 102 to base station 104 occurs. This handover is typically initiated by cellular telephone 108. In particular, as cellular telephone 108 is carried between coverage areas 112 and 114, it continuously monitors the strength of the signals that it receives from either or both of bases stations 102 and 104. At the point designated “A” in FIG. 1, cellular telephone 108 is tuned to base station 102 and can only receive signals from that base station, so no handover is initiated. At point “B”, however, cellular telephone 108 has moved into an area of overlap 118 where it receives signals from both base stations 102 and 104. At a point when the strength of the signals received from base station 104 exceeds that of signals received from base station 102, cellular telephone 108 tunes to base station 104 and then sends a control signal to the telecommunications network of which cellular telephone system 100 is a part. Responsive to the receipt of this control signal, the telecommunications network completes the handover by switching the communication session from base station 102 to base station 104 so that by the time cellular telephone 108 has moved to point “C”, base station 104 is handling the communication session.

The foregoing conventional handover process, in which handover is initiated by a moving handset in response to the detection of a weak signal from the originating base station and a stronger signal from the terminating base station, is referred to herein as a “cold handover.” An embodiment of the present invention operates, instead, by using a process that is termed herein a “hot handover.” In contrast to a cold handover, a hot handover is initiated by the telecommunications network rather than the handset. In particular, functionality within the telecommunications network monitors signals from a plurality of base stations and one or more mobile stations communicating therewith. Under certain predefined conditions, this functionality switches an active mobile communication session with a mobile station from a first base station to a second base station. Unlike a traditional cold handover, however, this handover can occur even when the mobile station is detecting equal or better signal strength from the first base station as compared to the second base station.

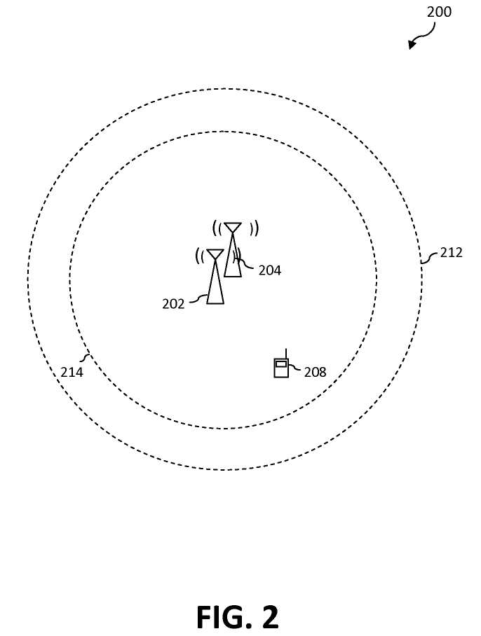

This concept will now be further explained in reference to FIG. 2. FIG. 2 depicts a portion of a WiMAX communication system 200 that is configured to provide increased effective bandwidth per base station without having to obtain additional RF spectrum. It is assumed for the purposes of this example that WiMAX communication system 200 operates using 10 MHz of RF bandwidth. When allocated across a cellular network using conventional technology, this 10 MHz of RF bandwidth roughly translates to about 8 Mbps of throughput or effective bandwidth per base station. However, as will be described below, WiMAX communication system 200 implements a cell site plan that utilizes the available 10 MHz RF bandwidth more effectively. As a result, using the same 10 MHz of RF bandwidth, the operator of WiMAX communication system 200 can obtain more than 20 Mbps of throughput or effective bandwidth per base station.

As shown in FIG. 2, the cell site plan provides for two base stations 202 and 204 operating within a single cell site area, wherein the base stations provide overlapping coverage. In particular, a coverage area 212 of base station 202 is greater than a coverage area 214 of base station 204, such that the coverage area of base station 202 encompasses that of base station 204. In one implementation, coverage area 212 of base station 204 is approximately 75-80% of coverage area 214 of base station 204.

First and second base stations 202 and 204 operate within the same 10 MHz of RF bandwidth. However, interference between the two base stations is avoided through the use of a frequency reuse technique and a special radiation pattern. Additionally, interference between first base station 202, which has a coverage area that preferably extends to the edges of the cell site area, and base stations in adjacent cell sites is avoided by sectorisation and adherence to a master network frequency plan. Interference between second base station 204 and the adjacent cell sites is avoided by limiting its coverage area 214, so that it does not extend to the edges of the cell sites.

Since base station 202 and 204 can each operate in the same frequency band, a mobile station that is located in an area where the coverage areas overlap (such as mobile station 208) can tune to either base station. This provides additional available bandwidth for servicing mobile stations located within the overlap area. In one implementation, first base station 202 is a low-capacity base station that is capable of providing an effective bandwidth of approximately 8 Mbps while second base station 204 is a high-capacity base station that is capable of providing an effective bandwidth of approximately 16 Mbps, resulting in a total effective bandwidth of 24 Mbps.

In practice, base stations 202 and 204 may be implemented as two separate physical units. Alternatively, base stations 202 and 204 may be implemented as two “virtual” base stations operating out of a single physical unit.

An embodiment of the present invention provides a mechanism by which mobile stations are switched from first base station 202 to second base station 204. In one implementation, when the bandwidth of low-capacity base station 202 is fully utilized, mobile stations are switched to high-capacity base station 204. Alternatively, even when the bandwidth of low-capacity base station 202 is not fully utilized, certain subscribers may be switched to high-capacity base station 204 to obtain better services and throughput. These may be subscribers that have purchased a more expensive calling plan, that are using more bandwidth-intensive applications, or both.

As discussed above, the switching of a mobile station from first base station 202 to second base station 204 is a “hot handover” because it is initiated by a telecommunications network (of which WiMAX communication system 200 is a part) and because it is not carried out in response to weakening signal strength from an originating base station and increasing signal strength from a terminating base station. As will be discussed in more detail herein, in one implementation, the “hot handover” is carried out, in part, using a protocol provided by the IEEE 802.16 standard for network initiated handovers. This is done to leverage the existing protocol and also to maximize interoperability with network component(s) that have been designed to implement that protocol.

### B. Example Operating Environment

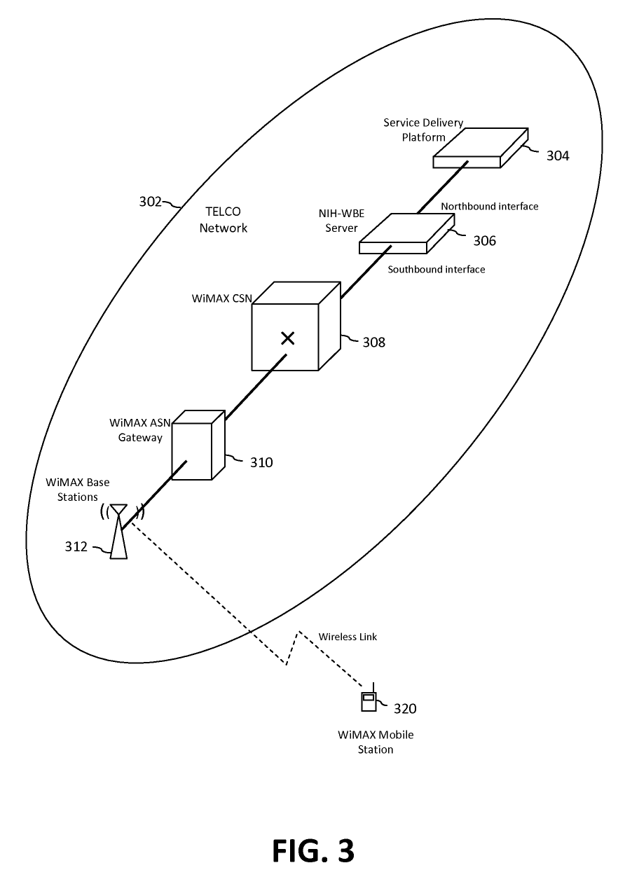

FIG. 3 is a high-level block diagram of a telecommunications (TELCO) network 302 in which an embodiment of the present invention may operate. As will be described in more detail herein, TELCO network 302 includes a server 306 that is adapted to perform certain features of the present invention. In this particular implementation, server 306 is entitled a Network Initiated Handover-WiMAX Bandwidth Enhancement (NIH-WBE) server, as it is used to increase the available bandwidth in a WiMAX communication system that forms a sub-part of network 302. However, persons skilled in the relevant art(s) will readily appreciate that the concepts of the present invention may be applied to other wireless broadband communication systems other than WiMAX systems. Thus, the title NIH-WBE server is not intended to limit the present invention.

As shown in FIG. 3, NIH-WBE server 306 is positioned deep within TELCO network 302. Server 306 is connected to and communicates with higher layer elements of TELCO network 302—namely, Service Delivery Platform (SDP) 304—through a northbound interface. SDP 304 is intended to represent a variety of well-known Operations Support System (OSS) and/or Business Support System (BSS) components that are typically deployed by a telecommunications network to provision and manage various services, including WiMAX communication services.

NIH-WBE server 306 is also connected to and communicates with well-known lower layer elements of TELCO network 302 through a southbound interface. These lower layer elements include a WiMAX Core Services Network (CSN) 308, a WiMAX Access Services Network (ASN) gateway 310, WiMAX base stations 312, and a WiMAX mobile station 320.

WiMAX CSN 308 is the part of network 300 that is responsible for switching WiMAX traffic. Conceptually, NIH-WBE server 306 may be considered a part of WiMAX CSN 308, since it is involved in the function of switching active mobile communication sessions as will be described in more detail herein. In some alternative implementations, NIH-WBE 306 interfaces directly to WiMAX ASN gateway 310 or WiMAX base stations 312.

WiMAX ASN gateway 310 is a network element that manages a number of WiMAX base stations 312. In certain WiMAX topologies, WiMAX ASN gateway 310 comprises part of WiMAX base stations 312 themselves. WiMAX base stations 312 are located within respective cells of the WiMAX communication system and operate to communicate wirelessly with WiMAX mobile stations within their cells, such as mobile station 320, by way of a wireless link.

### C. Example NIH-WBE Server in Accordance with an Embodiment of the Present Invention

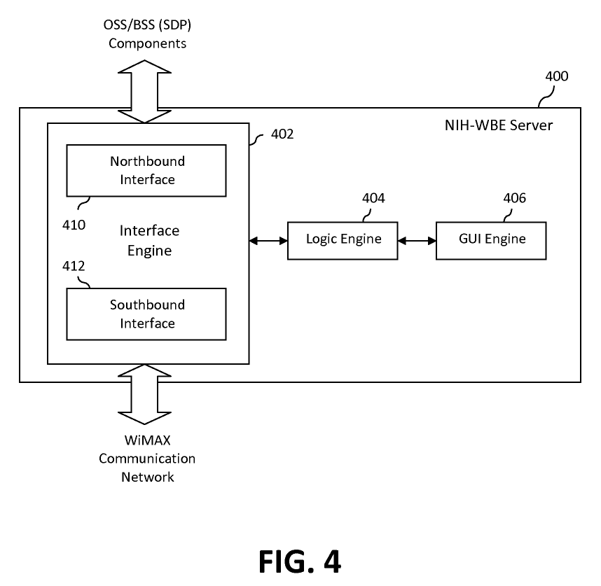

FIG. 4 is a high-level block diagram of an NIH-WBE server 400 in accordance with an embodiment of the present invention. In one implementation of the present invention, the functions and features of NIH-WBE server 400 as described herein are implemented as software which is executed by a computer or other hardware capable of executing such software. However, this example is not intended to be limiting, and persons skilled in the relevant art(s) will readily appreciate that the functions and features of NIH-WBE server 400 may be implemented in hardware, software, or a combination of thereof.

As shown in FIG. 4, the major functional elements of NIH-WBE server 400 include an interface engine 402, a logic engine 404 and a graphical user interface (GUI) engine 406. These elements will now be described.

Interface engine 402 includes a northbound interface 410 and a southbound interface 412. Interface engine 402 manages these interfaces to permit NIH-WBE server 400 to connect to and communicate with various external elements of TELCO network 300. In particular, northbound interface 410 is used to communicate with OSS/BSS elements of SDP 304, while southbound interface 412 is used to communicate with lower layer elements, which may include WiMAX CSN 308, WiMAX ASN gateway 310, and/or WiMAX base stations 312.

Logic engine 404 is the core of NIH-WBE server 400. As will be described in more detail herein, logic engine 404 is configured to perform the functions of initially setting up the WiMAX network elements to return crucial network parameters. Then, logic engine 404 compares certain predefined inputs and based on those inputs, determines whether or not to initiate a hot handover of an active mobile communication session from a first WiMAX base station to a second WiMAX base station. This decision is made on a per subscriber (or per mobile station) basis. In one implementation, these inputs include inputs from the underlying WiMAX communication system regarding signal strength and inputs from the overlay OSS/BSS components regarding the service privileges of that particular subscriber. If logic engine 404 determines that a hot handover should occur, then it commands the originating and terminating WiMAX base stations to physically implement the hot handover.

GUI engine 406 provides an interface by which TELCO staff can perform day-to-day operations, set various thresholds for initiating a hot handover, and generate and print various statistics and management reports. In one implementation, the interface is a Web-based interface. GUI engine 406 may further provide a multi-level operator log in which programmable rights can be defined for each level. Each level may further be password protected.

### D. Example Hot Handover Process in Accordance with an Embodiment of the Present Invention

An example of the process by which a hot handover is performed in accordance with an embodiment of the present invention will now be described. This process will be described with continued reference to TELCO network 302 of FIG. 3 and NIH-WBE server 400 of FIG. 4, although the present invention is not limited to those implementations.

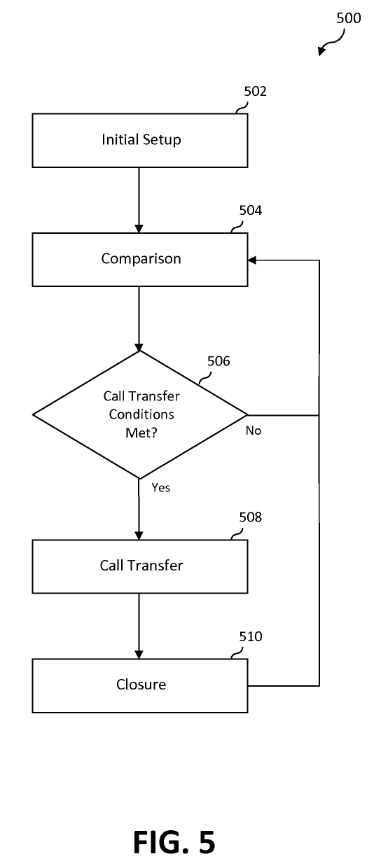

FIG. 5 illustrates a flowchart 500 of various steps associated with performing a hot handover in accordance with an embodiment of the present invention. As shown in FIG. 5, the first step is an initial setup step 502. During this step, logic engine 404 of NIH-WBE server 400 performs functions to determine which base stations are capable of participating in a hot handover and to obtain information from active mobile stations pertaining to which base stations each mobile station is capable of linking to and the signal strength associated with each. During comparison step 504, logic engine 404 determines whether or not a particular active mobile communication session should be transferred from a first base station to a second base station based on input from the mobile station and optionally from the OSS/BSS components of SDP 304. At decision step 506, if the results of the comparison indicate that the conditions for a transfer are not met, then control returns to step 504, in which a subsequent comparison is carried out for another active mobile communication session. However, if the results of the comparison indicate that the conditions for a transfer are met, then control proceeds to step 508, in which the active mobile communication session is transferred from the first base station to the second base station. At step 510, closure of the process occurs, during which NIH-WBE server 400 alerts the OSS/BSS components of SDP 304 that the hot handover has occurred for the particular mobile station. Control then returns to step 504, in which a subsequent comparison can be carried out for another active mobile communication session.

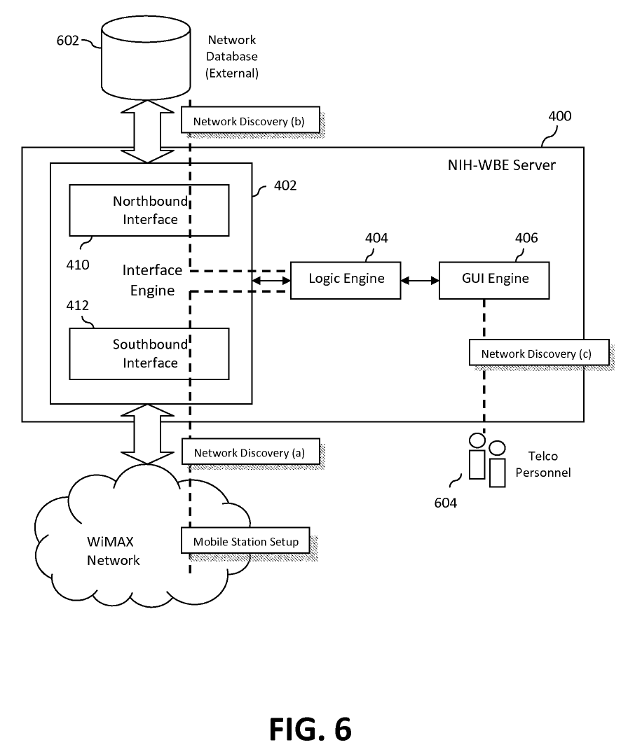

FIG. 6 illustrates a message flow associated with initial setup step 502 of FIG. 5. The initial setup process includes two phases: a network discovery phase and a mobile station setup phase. During the network discovery phase, logic engine 404 of NIH-WBE server 400 detects the active base stations within the portion of TELCO network 300 that it is managing. It also constructs a database of low-capacity and high-capacity base stations from this superset of active base stations. The database is stored in a memory that is internal with respect to server 400 (not shown in FIG. 6). Alternatively, the database may be stored in a memory that is external with respect to server 400 and to which server 400 is communicatively connected.

The information stored in the database may be (a) gathered automatically through communication with the WiMAX network elements, as indicated in FIG. 6 by the box labeled “Network Discovery (a),” (b) pulled from another database 602 stored in a high layer of TELCO network 300, as indicated in FIG. 6 by the box labeled “Network Discovery (b),” and/or (c) fed manually to server 400 by TELCO personnel 604 through GUI engine 406, as indicated in FIG. 6 by the box labeled “Network Discovery (c).”

During the mobile station setup phase of the initial setup, logic engine 404 of NIH-WBE server 400 utilizes standard commands from the IEEE 802.16 protocol to instruct WiMAX mobile stations engaged in an active mobile communication session via a first base station to alert TELCO network 300 when the mobile station senses a second base station. This is a broadcast command and is sent out to all mobile stations.

A WiMAX mobile station, under normal conditions, continuously scans for active base stations in its vicinity. Once it has detected a base station, it completes a standard log on procedure and logs onto the network. After logging on, it continues to scan for active base stations. When the signal strength of the base station to which it is currently attached weakens and it also detects another base station nearby with a strong signal, it initiates and completes a “cold handover” in a manner similar to that described above in Section A in reference to conventional cellular telephone networks.

In response to specific WiMAX protocol command from NIH-WBE server 400, each mobile station relays the base station and signal strength information that it normally tracks for performing a cold handover, as described above, to NIH-WBE server 400, which uses such information for making a hot handover decision as will be described in more detail herein. The broadcasting of the WiMAX protocol command and the return of the base station and signal strength information is generally indicated in FIG. 6 by the box labeled “Mobile Station Setup.”

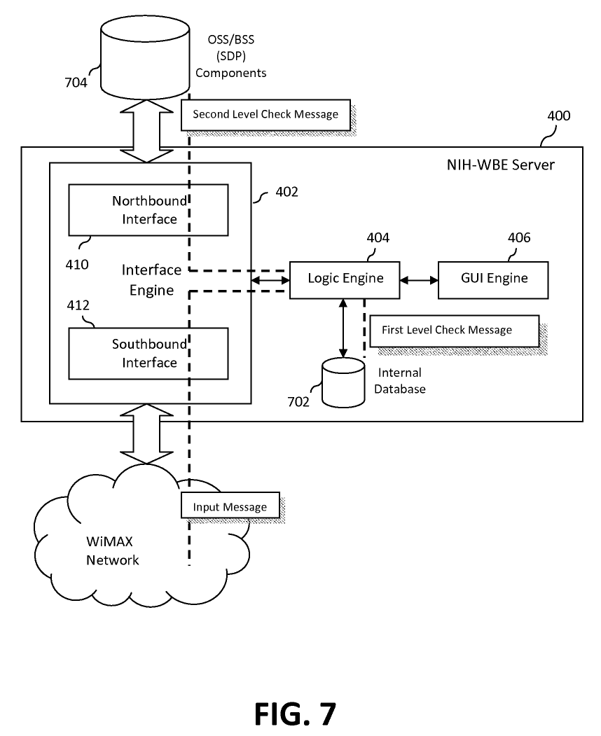

FIG. 7 illustrates a message flow associated with comparison step 504 and decision step 506 of FIG. 5. At the beginning of comparison step 504, logic engine 404 of NIH-WBE server 400 receives an alert, or input message, from a mobile station that is currently linked to a first WiMAX base station but is detecting a second WiMAX base station. This transmission of this message is indicated in FIG. 7 by the box labeled “Input Message.”

Upon receipt of the alert, logic engine 404 performs a first level check. During the first level check, logic engine 404 consults its internal database 702 to determine if the second base station is a high-capacity base station. This exchange is indicated in FIG. 7 by the box labeled “First Level Check Message.” If the second base station is not a high-capacity base station, then the conditions for conducting a hot transfer have not been met. Consequently, decision step 506 will generate a “no” and control will return to comparison step 504 for the performance of further comparisons.

However, if the second base station is a high-capacity base station, then logic engine 404 performs a second level check. During the second level check, logic engine 404 queries OSS/BSS components 704 of SDP 304 through northbound interface 410 to determine if the subscriber associated with the mobile station has the right to access a high-bandwidth base station. Such eligibility may be based upon the subscriber's participation in a particular service plan, upon the bandwidth demands associated with the active mobile communication session in which the subscriber is participating or upon different conditions entirely. The querying of OSS/BSS components 704 to make this determination is indicated by the box labeled “Second Level Check Message” in FIG. 7.

If the first level check indicates that the second base station is a high-capacity base station and the mobile station is sensing a strong signal from that base station, and if the second level check indicates that the subscriber is eligible for a handover to the second base station, then the conditions for call transfer have been met. As a result, decision step 506 will generate a “yes” and control will pass to call transfer step 508. Note that the conditions for a call transfer can be met even when the signal strength associated with the second base station is less than the signal strength associated with the first base station.

Alternative methods for determining whether to perform a call transfer are within the scope and spirit of the present invention. For example, in one implementation, logic engine 404 receives a message from an OSS/BSS component of SDP 304 through northbound interface 410 to move a specific subscriber engaged in an active mobile communication session from a low-capacity base station to a high-capacity base station. The OSS/BSS component may generate this message based upon network traffic conditions and/or the need to perform load balancing between base stations.

In another implementation, logic engine 404 receives a command from GUI 406 to move a specific subscriber engaged in an active mobile communication session from a low-capacity base station to a high-capacity base station. This command is generated by GUI 406 in response to manual input received from the TELCO operations staff. Such an approach might be used only in very special and rare circumstances—such as, for example, in response to a network failure and the need to re-route traffic.

In a further implementation, logic engine 404 initiates the hot handover based on only one source of input—namely, the mobile station. In this implementation, if the mobile handset senses a strong signal from the second base station, and the base station is a high-capacity base station, then the conditions for call transfer will have been met. No querying of the OSS/BSS components of SDP 304 is necessary. Rather, all the subscribers are automatically assumed to be eligible and the hot handover decision is made without this additional input.

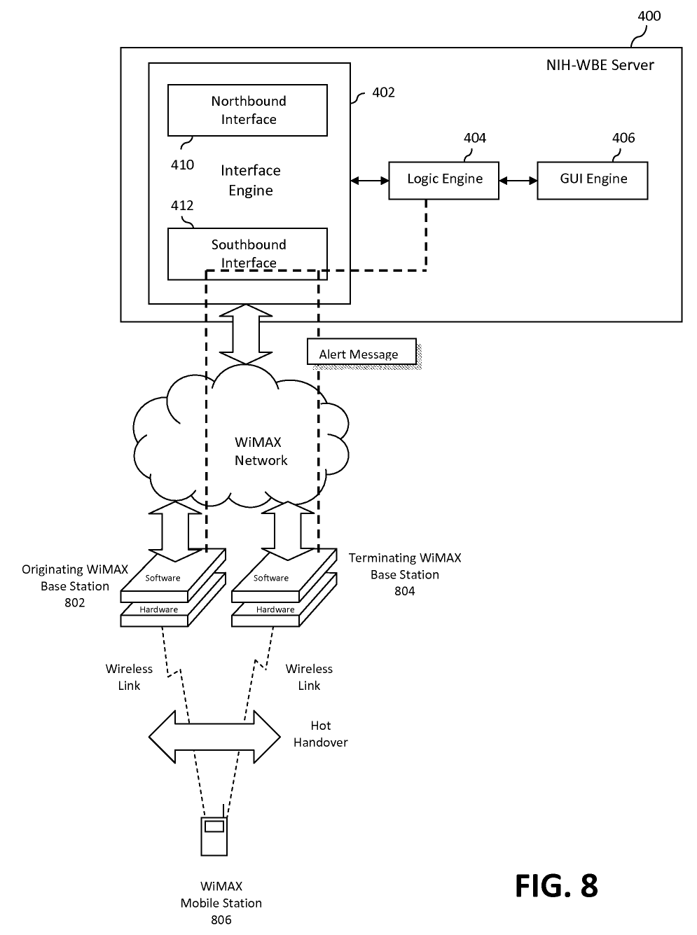

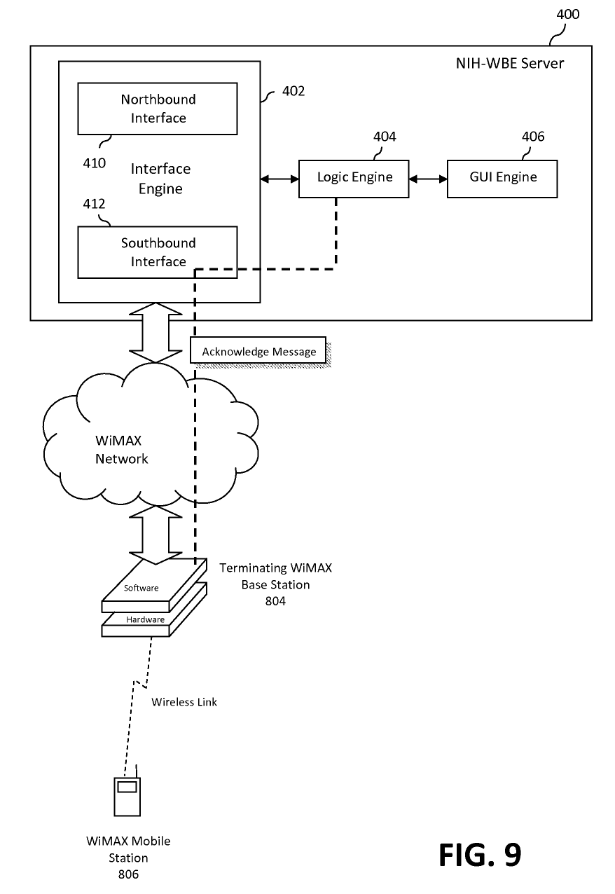

FIGS. 8 and 9 illustrate message flows associated with call transfer step 508 of FIG. 5. Once logic engine 404 of NIH-WBE server 400 decides to perform a hot handover for a particular active mobile communication session, it sends out messages to both the first base station, denoted originating base station 802, and to the second base station, denoted terminating base station 804. These messages are targeted commands to specific base stations rather than a broadcast command. The messages are relayed to the base stations by WiMAX CSN 308 and WiMAX ASN Gateway 310. The transmission of these messages to base stations 802 and 804 is indicated in FIG. 8 by the box labeled “Alert Message.” In response to these messages, the active mobile communication session associated with a mobile station 806 is transferred from originating base station 802 to terminating base station 804.

Once the hot handover is accomplished, terminating base station 804 sends an acknowledgement signal back to NIH-WBE server 400 via WiMAX ASN Gateway 310 and WiMAX CSN 308. The transmission of this acknowledgement signal is indicated in FIG. 9 by the box labeled “Acknowledgement Message.”

In an implementation of the present invention, the messages sent to originating and terminating base stations 802 and 804 to execute the hot handover are sent as part of the Network Initiated Handover protocol already provided for in the IEEE 802.16 standard. This approach may be deemed preferable in order to leverage the existing protocol as well as to maximize interoperability with other network components already configured to use it. The Network Initiated Handover feature is referenced at Sections 7.7.2.2.3 and 7.9.4.2.1 of WIMAX END-TO-END NETWORK SYSTEMS ARCHITECTURE (STAGE 2: ARCHITECTURE TENETS, REFERENCE MODEL AND REFERENCE POINTS)[PART 2], published Aug. 8, 2006 by the WiMAX Forum, the entirety of which is incorporated by reference herein and at Sections 5.9.5.1 and 9.1.4.1.2 of WIMAX END-TO-END NETWORK SYSTEMS ARCHITECTURE (STAGE 3: DETAILED PROTOCOLS AND PROCEDURES), published Aug. 8, 2006 by the WiMAX Forum, the entirety of which is also incorporated by reference herein. Section 9.1.4.1.2 of the latter reference, in particular, provides useful information concerning setup associated with the Network Initiated Handover feature.

It is noted that Section 7.9.4.2.1 of WIMAX END-TO-END NETWORK SYSTEMS ARCHITECTURE (STAGE 2: ARCHITECTURE TENETS, REFERENCE MODEL AND REFERENCE POINTS)[PART 2] and Section 5.9.5.1 of WIMAX END-TO-END NETWORK SYSTEMS ARCHITECTURE (STAGE 3: DETAILED PROTOCOLS AND PROCEDURES) each discuss the use of the Network Initiated Handover feature of WiMAX for load balancing. However, these sections do not deal with the transfer of an active mobile communication session from an originating base station to a terminating base station as described herein, but rather deal with the assignment of a mobile station to a base station when it first logs onto the WiMAX network. Furthermore, these sections do not contemplate the transfer of a mobile station from a low-capacity base station to a high-capacity base station as described herein. Finally, these sections describe a use of the Network Initiated Handover feature in which all the necessary inputs are received from layers lower than the WiMAX CSN, whereas certain embodiments of the present invention make the hot handover decision based on inputs received from higher layer components, such as the OSS/BSS components of the SDP.

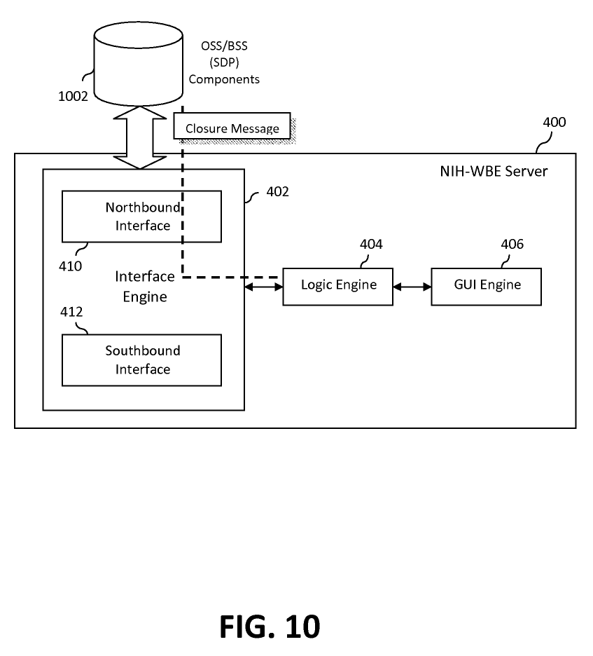

FIG. 10 illustrates a message flow associated with closure step 510 of FIG. 5. During closure step 510, NIH-WBE server 400 alerts OSS/BSS components 1002 of SDP 304 that the hot handover has occurred for a particular subscriber (or mobile station) and provides a time and date indicating when the handover occurred. This information can be used by OSS/BSS components 1002 for billing purposes. The transmission of this information to OSS/BSS components 1002 is indicated in FIG. 10 by the box labeled “Closure Message.”

### E. Example Processor-Based Server Implementation in Accordance with an Embodiment of the Present Invention

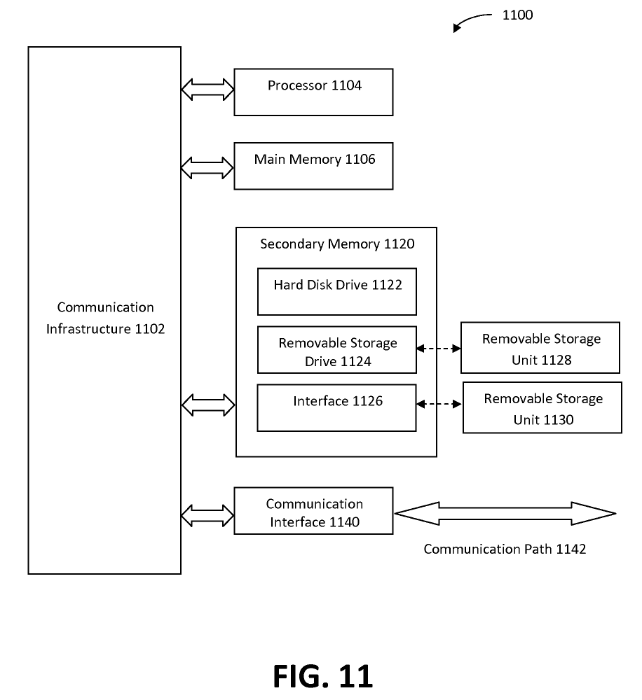

As noted above, in one implementation of the present invention, the functions and features of NIH-WBE server 400 are implemented as software which is executed by a computer system or other hardware capable of executing such software. FIG. 11 is a block diagram of an example processor-based computer system 1100 upon which such software may be executed. This description of computer system 1100 is provided for the sake of completeness only and is not intended to limit the present invention. As noted above, NIH-WBE server 400 may be implemented in hardware, software or as a combination of software and hardware.

As shown in FIG. 11, computer system 1100 includes one or more processors, such as processor 1104. Processor 1104 can be a special purpose or a general purpose processor. Processor 1104 is connected to a communication infrastructure 1102 (for example, a bus or network).

Computer system 1100 also includes a main memory 1106, preferably random access memory (RAM), and may also include a secondary memory 1120. Secondary memory 1120 may include, for example, a hard disk drive 1122, a removable storage drive 1124, and/or a memory stick. Removable storage drive 1124 may comprise a floppy disk drive, a magnetic tape drive, an optical disk drive, a flash memory, or the like. Removable storage drive 1124 reads from and/or writes to a removable storage unit 1128 in a well-known manner. Removable storage unit 1128 may comprise a floppy disk, magnetic tape, optical disk, or the like, which is read by and written to by removable storage drive 1124. As will be appreciated by persons skilled in the relevant art(s), removable storage unit 1128 includes a computer usable storage medium having stored therein computer software and/or data.

In alternative implementations, secondary memory 1120 may include other similar means for allowing computer programs or other instructions to be loaded into computer system 1100. Such means may include, for example, a removable storage unit 1130 and an interface 1126. Examples of such means may include a program cartridge and cartridge interface (such as that found in video game devices), a removable memory chip (such as an EPROM, or PROM) and associated socket, and other removable storage units 1130 and interfaces 1126 which allow software and data to be transferred from the removable storage unit 1130 to computer system 1100.

Computer system 1100 may also include a communications interface 1140. Communications interface 1140 allows software and data to be transferred between computer system 1100 and external devices. Examples of communications interface 1140 may include a modem, a network interface (such as an Ethernet card), a communications port, a PCMCIA slot and card, or the like. Software and data transferred via communications interface 1140 are in the form of signals which may be electronic, electromagnetic, optical, or other signals capable of being received by communications interface 1140. These signals are provided to communications interface 1140 via a communications path 1142. Communications path 1142 carries signals and may be implemented using wire or cable, fiber optics, a phone line, a cellular phone link, an RF link and other communications channels.

As used herein, the terms “computer program medium” and “computer usable medium” are used to generally refer to media such as removable storage unit 1128, removable storage unit 1130, a hard disk installed in hard disk drive 1122, and signals received by communications interface 1140. Computer program medium and computer useable medium can also refer to memories, such as main memory 1106 and secondary memory 1120, which can be semiconductor devices (e.g., DRAMs, etc.). These computer program products are means for providing software to computer system 1100.

Computer programs (also called computer control logic) are stored in main memory 1106 and/or secondary memory 1120. Computer programs may also be received via communications interface 1140. Such computer programs, when executed, enable the computer system 1100 to implement features of the present invention as discussed herein. In particular, the computer programs, when executed, enable the processor 1100 to implement features of the NIH-WBE server 400 as described herein. Accordingly, such computer programs represent controllers of the computer system 1100. Where the invention is implemented using software, the software may be stored in a computer program product and loaded into computer system 1100 using removable storage drive 1124, interface 1126, or communications interface 1140.

The invention is also directed to computer program products comprising software stored on any computer useable medium. Such software, when executed in one or more data processing devices, causes a data processing device(s) to operate as described herein. Embodiments of the present invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, zip disks, tapes, magnetic storage devices, optical storage devices, MEMs, nanotechnology-based storage device, etc.), and communication mediums (e.g., wired and wireless communication networks, local area networks, wide area networks, intranets, etc.).

### F. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for performing a handover in a broadband wireless communication system, comprising:
acquiring information from a mobile station that is engaged in an active mobile communication session over the broadband wireless communication system via a wireless link to a first base station, the acquired information indicating that the mobile station is capable of wirelessly communicating with both the first base station and a second base station and also indicating that the strength of a signal from the second base station does not exceed the strength of a signal from the first base station; and
sending commands to the first base station and the second base station to transfer the active mobile communication session from the first base station to the second base station based at least in part on the information acquired from the mobile station.

2. The method of claim 1, wherein the broadband wireless communication system is a WiMAX communication system.

3. The method of claim 2, wherein sending commands to the first base station and the second base station to transfer the active mobile communication session from the first base station to the second base station comprises performing a network initiated handover in accordance with an IEEE 802.16 standard.

4. The method of claim 1, wherein the second base station has a higher capacity than the first base station.

5. The method of claim 1, wherein the active mobile communication session is one of a voice communication session, a data communication session or a video communication session.

6. The method of claim 1, further comprising:
acquiring information from a component in a telecommunications network indicating that a subscriber associated with the mobile station is eligible for a handover from the first base station to the second base station;
wherein the step of sending commands to the first base station and the second base station to transfer the active mobile communication session from the first base station to the second base station is performed based at least in part on the information acquired from the mobile station and the information acquired from the component in the telecommunications network.

7. The method of claim 6, wherein acquiring information from a component in a telecommunications network comprises acquiring information from an Operations Support System (OSS) component or a Business Support System (BSS) component in the telecommunications network.

8. The method of claim 1, further comprising:
receiving a command from a component in a telecommunications network indicating that the mobile station should be transferred from the first base station to the second base station;
wherein the step of sending commands to the first base station and the second base station to transfer the active mobile communication session from the first base station to the second base station is performed based at least in part on the information acquired from the mobile station and the command received from the component in the telecommunications network.

9. The method of claim 8, wherein receiving a command from a component in a telecommunications network comprises receiving a command from an Operations Support System (OSS) component or a Business Support System (BSS) component in the telecommunications network.

10. The method of claim 1, further comprising:
passing information concerning the transfer of the active mobile communication session from the first base station to the second base station to a component in a telecommunications network for billing and/or customer management purposes.

11. The method of claim 1, further comprising:
receiving input from a user via a graphical user interface; and
based on the input, setting one or more programmable parameters or thresholds relating to conditions under which a transfer of an active mobile communication session from the first base to the second base station should occur.

12. A server for use in a telecommunications network that includes a broadband wireless communication system, comprising:
a first interface; and
a logic engine communicatively connected to the first interface;
wherein the logic engine is configured to acquire via the first interface information from a mobile station that is engaged in an active mobile communication session over the broadband wireless communication system via a wireless link to a first base station, the acquired information indicating that the mobile station is capable of wirelessly communicating with both the first base station and a second base station and also indicating that the strength of a signal from the second base station does not exceed the strength of a signal from the first base station, and
wherein the logic engine is further configured to send via the first interface commands to the first base station and the second base station to transfer the active mobile communication session from the first base station to the second base station based at least in part on the information acquired from the mobile station.

13. The server of claim 12, wherein the broadband wireless communication system is a WiMAX communication system.

14. The server of claim 13, wherein the logic engine is configured to send commands to the first base station and the second base station to transfer the active mobile communication session from the first base station to the second base station as part of a network initiated handover in accordance with an IEEE 802.16 standard.

15. The server of claim 12, wherein the second base station has a higher capacity than the first base station.

16. The server of claim 12, wherein the active mobile communication session is one of a voice communication session, a data communication session or a video communication session.

17. The server of claim 12, wherein the server further comprises:
a second interface to which the logic engine is communicatively connected;
wherein the logic engine is further configured to acquire information via the second interface from a component in the telecommunications network indicating that a subscriber associated with the mobile station is eligible for a handover from the first base station to the second base station, and
wherein the logic engine is configured to send commands to the first base station and the second base station to transfer the active mobile communication session from the first base station to the second base station based at least in part on the information acquired from the mobile station and the information acquired from the component in the telecommunications network.

18. The server of claim 17, wherein the component in the telecommunications network comprises an Operations Support System (OSS) component or a Business Support System (BSS) component.

19. The server of claim 12, further comprising:
a second interface to which the logic engine is communicatively connected;
wherein the logic engine is further configured to receive a command via the second interface from a component in the telecommunications network indicating that the mobile station should be transferred from the first base station to the second base station, and
wherein the logic engine is configured to send commands to the first base station and the second base station to transfer the active mobile communication session from the first base station to the second base station based at least in part on the information acquired from the mobile station and the command received from the component in the telecommunications network.

20. The server of claim 19, wherein the component in the telecommunications network comprises an Operations Support System (OSS) component or a Business Support System (BSS) component.

21. A computer program product comprising a computer useable medium having computer program logic recorded thereon for enabling a processor to initiate a handover in a broadband wireless communication network, the computer program logic comprising:
first means for enabling the processor to acquire information from a mobile station that is engaged in an active mobile communication session over the broadband wireless communication system via a wireless link to a first base station, the acquired information indicating that the mobile station is capable of wirelessly communicating with both the first base station and a second base station and also indicating that the strength of a signal from the second base station does not exceed the strength of a signal from the first base station; and
second means for enabling the processor to send commands to the first base station and the second base station to transfer the active mobile communication session from the first base station to the second base station based at least in part on the information acquired from the mobile station.

22. The computer program product of claim 21, wherein the broadband wireless communication system is a WiMAX communication system.

23. The computer program product of claim 22, wherein the second means comprises means for enabling the processor to initiate a network initiated handover in accordance with an IEEE 802.16 standard.

24. The computer program product of claim 21, wherein the second base station has a higher capacity than the first base station.

25. The computer program product of claim 21, wherein the active mobile communication session is one of a voice communication session, a data communication session or a video communication session.

26. The computer program product of claim 21, wherein the computer program logic further comprises:
third means for enabling the processor to acquire information from a component in a telecommunications network indicating that a subscriber associated with the mobile station is eligible for a handover from the first base station to the second base station;
wherein the second means comprises means for enabling the processor to send commands to the first base station and the second base station to transfer the active mobile communication session from the first base station to the second base station based at least in part on the information acquired from the mobile station and the information acquired from the component in the telecommunications network.

27. The computer program product of claim 26, wherein the third means comprises means for enabling the processor to acquire information from an Operations Support System (OSS) component or a Business Support System (BSS) component in the telecommunications network.

28. The computer program product of claim 21, wherein the computer program logic further comprises:
third means for enabling the processor to receive a command from a component in a telecommunications network indicating that the mobile station should be transferred from the first base station to the second base station;
wherein the second means comprises means for enabling the processor to send commands to the first base station and the second base station to transfer the active mobile communication session from the first base station to the second base station based at least in part on the information acquired from the mobile station and the command received from the component in the telecommunications network.

29. The computer program product of claim 28, wherein the third means comprises means for enabling the processor to receive a command from an Operations Support System (OSS) component or a Business Support System (BSS) component in the telecommunications network.
